(19) United States
(12) Patent Application Publication
(10) Pub. No.: US 2025/0296764 A1
(43) Pub. Date: Sep. 25, 2025

(54) SYSTEM FOR STORING AND TRANSPORTING A PRIMARY LIFE SUPPORT SUBSYSTEM AND HARD UPPER TORSO

(71) Applicant: Hamilton Sundstrand Space Systems International, Inc., Windsor Locks, CT (US)

(72) Inventor: Emily Muggleton, Brooklyn, NY (US)

(21) Appl. No.: 18/610,948

(22) Filed: Mar. 20, 2024

(51) Int. Cl. B64G 6/00

(52) U.S. Cl. CPC B65D 85/18; B64G 6/00

(57) ABSTRACT

A system for storing a PLSS connected to a HUT of an atmospheric suit, having a frame with: a frame top and bottom; first and second frame ends; and first and second frame sides, the PLSS is storable and removable via the frame top; attachment assemblies releasably connected to the frame top along the frame sides, the attachment assemblies each include: a first bracket extending between first and second bracket sides and between first and second bracket ends; a fixed oblong-shaped boss connected to the first bracket side; and a fixed pin-shaped boss connected to the second bracket side, the attachment assemblies are selectively arrangeable in a first orientation in which the oblong-shaped bosses face each other to fix the PLSS to the frame, and a second orientation in which the oblong-shaped bosses face away from each other to releasably position the PLSS against the frame.

### BACKGROUND

Exemplary embodiments pertain to the art of transportation equipment for storing and transporting gear for space exploration and more specifically to a system for storing and transporting a primary life support subsystem (PLSS) and hard upper torso (HUT).

Transporting and storing a PLSS and HUT may require using separate implements. A transportation implement may be utilized for transporting the PLSS and HUT from an initial location to an end destination, such as between the earth and an orbital destination of a spaceship or a stationary body such as the moon. A storage implement may be utilized for storing the PLSS and HUT at the end destination, where it is intended to be periodically retrieved, donned, doffed and stored again. The use of separate implements can result in a waste of space, and energy, in ships that are required to transport both implements from the initial location to the final destination. This can result in material waste if, for example, both implements are intended to be permanently left at the end destination, which may be a requirement of a space mission. For example, if the final destination is a stationary object such as a station on the moon, the mission agenda may include leaving both implements there. The transportation implement may be left on the moon to save energy or allow for transportation of other cargo on a spaceship for a return trip to the earth. The storage implement also may be left on the moon with the PLSS and HUT for storage and future use of the PLSS and HUT.

### BRIEF DESCRIPTION

Disclosed is a system for storing a primary life support subsystem (PLSS) that is connected to a hard upper torso (HUT) of an atmospheric suit, the system including: a frame having: a top and a bottom that are spaced apart from each other in a depth direction; first and second ends that are spaced apart from each other in a longitudinal direction; and first and second sides that are spaced apart in a transverse direction, and the PLSS is storable and removable via the top of the frame; a first set of attachment assemblies, including first and second attachment assemblies, releasably connected to the top of the frame, along the first and second sides of the frame, wherein the first and second attachment assemblies each include: a first bracket extending transversely between first and second sides and longitudinally between first and second ends; a fixed oblong-shaped boss connected to the first side of the bracket and extending in the longitudinal direction; and a fixed pin-shaped boss connected to the second side of the bracket and extending in the transverse direction, wherein the first set of attachment assemblies is selectively arrangeable in a first orientation in which the oblong-shaped boss of the first and second attachment assemblies face each other to fix the PLSS to the frame, and a second orientation in which the oblong-shaped boss of the first and second attachment assemblies face away from each other to releasably position the PLSS against the frame.

In addition to one or more aspects of the system or as an alternate, the frame is shaped as a rectangular parallelepiped; and a longitudinal size of the frame is greater than a transverse size of the frame, and the transverse size of the frame is greater than a depth of the frame.

In addition to one or more aspects of the system or as an alternate, the first and second attachment assemblies further include a first flange secured to the first side of the bracket and a second flange secured to the second side of the bracket; and the oblong-shaped boss is integral with the first flange and the pin-shaped boss is integral with the second flange.

In addition to one or more aspects of the system or as an alternate, the first and second attachment assemblies further include a block portion, longitudinally centered on the bracket of the first and second attachment assemblies; the block portion defines a channel that extends in the transverse direction, between the first and second sides of the bracket; and a shaft is disposed in the channel, extending between the first and second flanges, so that the oblong-shaped boss, the shaft, and the pin-shaped boss form an integral structure.

In addition to one or more aspects of the system or as an alternate, fasteners secure the first and second flanges to the bracket, wherein the fasteners engage the first and second flanges in the transverse direction.

In addition to one or more aspects of the system or as an alternate, the first set of attachment assemblies is releasably secured to the frame via fasteners that engage the frame in the depth direction.

In addition to one or more aspects of the system or as an alternate, the fasteners are bolts or screws.

In addition to one or more aspects of the system or as an alternate, the system includes fastener standoffs, wherein when the fasteners are secured to the frame, heads of the fasteners are spaced in the depth direction from the frame via the fastener standoffs.

In addition to one or more aspects of the system or as an alternate, the system includes a second set of attachment assemblies, including third and fourth attachment assemblies, each including: a second bracket; a spring-loaded retractable pin-shaped boss connected to the second bracket and extending inwardly in the transverse direction, whereby the retractable pin-shaped boss in the third and fourth attachment assemblies face each other; and a lever secured to the bracket, wherein the lever is pivotable to retract the retractable pin-shaped boss.

In addition to one or more aspects of the system or as an alternate, when the oblong-shaped boss of the first and second attachment assemblies face each other and engage the PLSS, the PLSS is fixed to the frame; and when the fixed pin-shaped boss of the first and second attachment assemblies face each other and engage the PLSS, and the retractable pin-shaped boss is retracted, the PLSS is removable from the frame.

In addition to one or more aspects of the system or as an alternate, the first set of attachment assemblies are closer to the first end of the frame than the second set of attachment assemblies.

In addition to one or more aspects of the system or as an alternate, the frame is formed of frame members such the top and bottom of the frame each include: first and second end frame members that are spaced apart in the longitudinal direction; and first and second side frame members that are spaced apart in the transverse direction.

In addition to one or more aspects of the system or as an alternate, the system includes base stiffening panels, including: first and second base side panels connected to the frame members along ones of the first and second sides of the frame; first and second base end panels connected to the frame members along ones of the first and second ends of the frame; and a bottom panel connected to the frame members along the bottom of the frame.

In addition to one or more aspects of the system or as an alternate, the system includes HUT cover panels, including: first and second cover side panels connected to the frame members along ones of the first and second sides of the frame, each extending in the depth direction away from the top of the frame to an outer end, wherein the first and second cover side panels of the HUT cover define contours that fit about each of the first and second sets of attachment assemblies; first and second cover end panels connected to the frame members along ones of the first and second ends of the frame, each extending in the depth direction away from the top of the frame to outer ends; and a top panel connected to the outer ends of the first and second cover side panels and the first and second cover end panels of the cover panels.

In addition to one or more aspects of the system or as an alternate, the top panel defines a center aperture though which a portion of a top of the HUT extends when the PLSS and HUT are secured to the frame; and the top panel includes a supplemental cover portion that covers the portion of the top of the HUT.

In addition to one or more aspects of the system or as an alternate, the system includes a PLSS having a top, a bottom and first and second sides, and a HUT connected to the top of the PLSS, wherein the PLSS includes: a first set of slots, including first and second slots, each having an outer portion that extends in the depth direction from the bottom of the PLSS to an inner slot end that is intermediate the top and the bottom, and a longitudinally extending oblong-shaped groove is defined at the inner slot end of the first set of slots; and a second set of slots, including third and fourth slots, each extending in the depth direction from the bottom of the PLSS to an inner slot end that is intermediate the top and the bottom, and a pin-shaped groove is defined at the inner slot end of the second set of slots.

In addition to one or more aspects of the system or as an alternate, in the first orientation of the first set of attachment assemblies: the oblong-shaped boss of the first and second attachment assemblies extend into the oblong-shaped groove of the first and second slots; the retractable pin-shaped boss of the third and fourth attachment assemblies extend into the pin-shaped groove of the third and fourth slots; and the PLSS is fixed to the frame.

In addition to one or more aspects of the system or as an alternate, in the second orientation of the first set of attachment assemblies: the fixed pin-shaped boss of the first and second attachment assemblies extend into the oblong-shaped groove of the first and second slots; the retractable pin-shaped boss of the third and fourth attachment assemblies extend into the pin-shaped groove of the third and fourth slots; and engaging the lever of the third and fourth attachment assemblies retracts the retractable pin-shaped boss of the third and fourth attachment assemblies, whereby the PLSS is removable from the frame.

### BRIEF DESCRIPTION OF THE DRAWINGS

The following descriptions should not be considered limiting in any way. With reference to the accompanying drawings, like elements are numbered alike:

FIG. 1A shows a spacesuit with a primary life support subsystem (PLSS) and hard upper torso (HUT);

FIG. 1B shows slots formed into the PLSS for storing the PLSS and HUT, according to an embodiment;

FIG. 1C shows details of one of the slots of the PLSS;

FIG. 1D shows details of another one of the slots of the PLSS;

FIG. 2 shows a frame for storing and transporting the PLSS, according to an embodiment;

FIG. 3 shows the frame of FIG. 2 and identifies first and second attachment assemblies, according to an embodiment;

FIG. 4 shows details of one of the first and second attachment assemblies;

FIG. 5 shows additional details of the one of the first and second attachment assemblies;

FIG. 6 shows the frame of FIG. 2 and identifies third and fourth attachment assemblies, according to an embodiment, and shows details of the one of the third and fourth attachment assemblies;

FIG. 7A shows the first and second attachment assemblies in a first orientation on the frame, and shows a PLSS and HUT secured to the frame;

FIG. 7B is a perspective view of the assembly of FIG. 7A;

FIG. 8A shows the first and second attachment assemblies in a second orientation on the frame, and shows a PLSS and HUT secured to the frame;

FIG. 8B is a perspective view of the assembly of FIG. 8A;

FIG. 9 shows the frame with stiffening panels, according to an embodiment;

FIG. 10 shows cover panels connected to the frame, with two of the panels not illustrated for simplicity and to show the PLSS and HUT connected to the frame; and

FIG. 11 shows the cover panels connected to the frame, without a PLSS and HUT connected to the frame.

### DETAILED DESCRIPTION

A detailed description of one or more embodiments of the disclosed apparatus and method are presented herein by way of exemplification and not limitation with reference to the Figures.

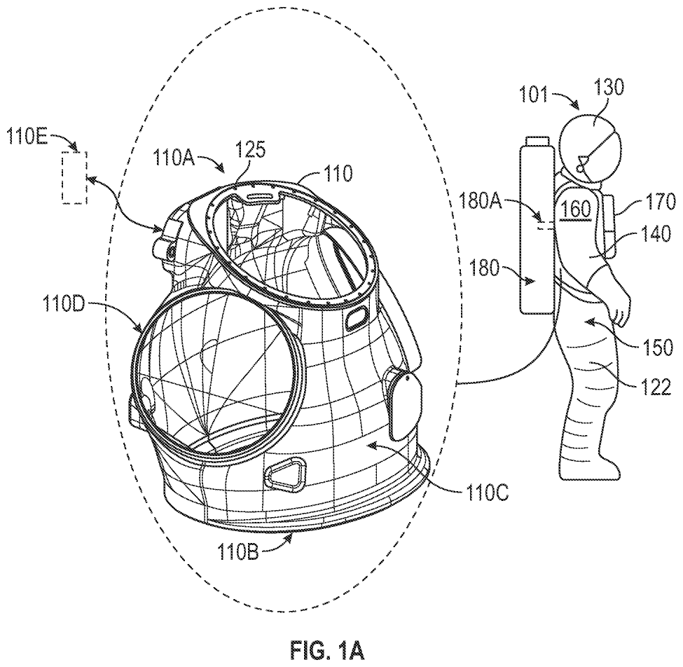

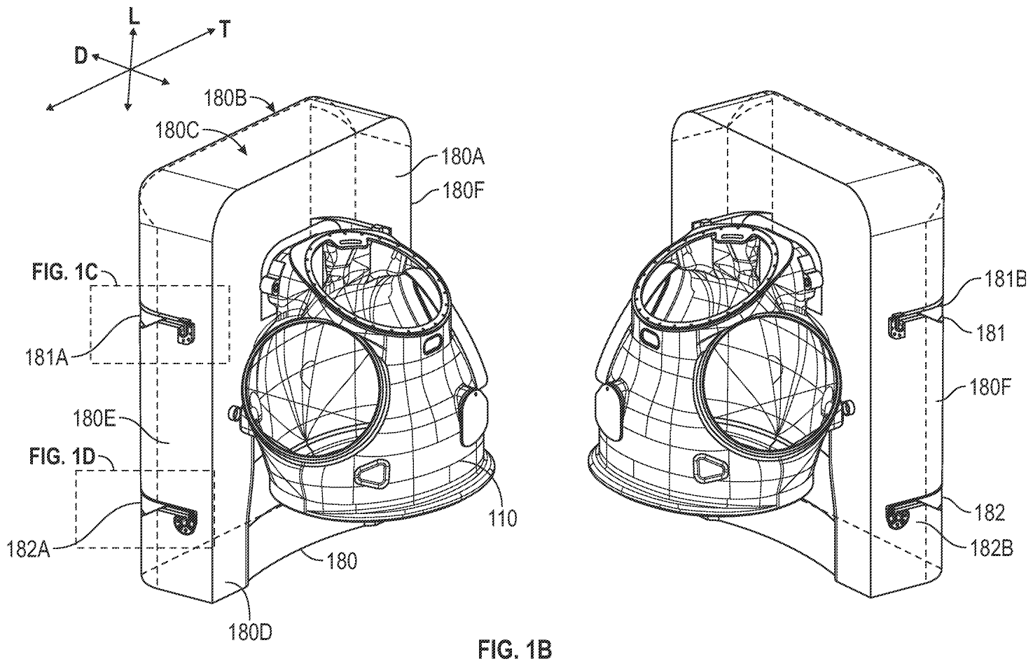

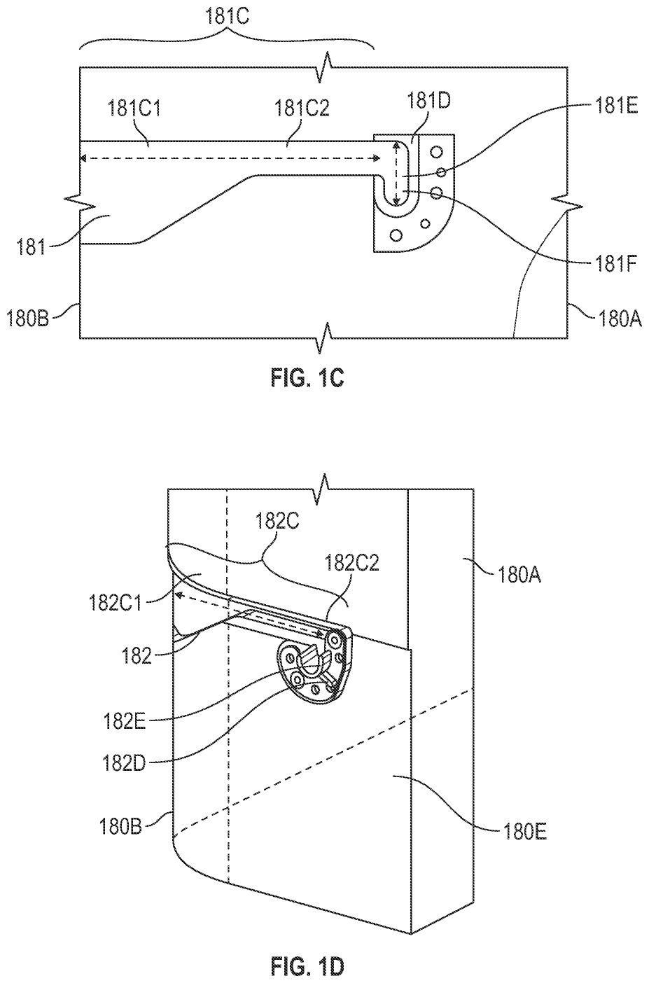

FIG. 1A depicts components 101 of an atmospheric suit (or spacesuit) 100 according to one or more embodiments. The figure shows a hard upper torso (HUT) 110 having a top 110A, a bottom 110B, a front 110C and a back 110D, and the HUT 110 is donned and doffed from the bottom 110B. The HUT 110 acts as an attachment point for other components 101 of the atmospheric suit 100. For example, the HUT 110 includes a neck ring 125 to which the helmet 130 is attached. The arms 140 and lower torso assembly (LTA) 150 also are components 101 that attach to the HUT 110, along with a display and control module (DCM) 170 and a primary life support subsystem (PLSS) 180. The HUT 110 is covered by a thermal micrometeoroid garment (TMG) 160 that forms the atmospheric suit 100. The HUT 110 may connect to the PLSS 180 via, e.g., brackets 110E (shown schematically) located on the back 110D of the HUT 110 that connect with mounting studs 180A (shown schematically) on the PLSS 180, as nonlimiting examples.

Turing to FIG. 1B, additional details of the PLSS 180 are shown. The PLSS 180 is illustrated as a rectangular box for simplicity. The PLSS 180 has top (or front) and bottom (or back) walls 180A, 180B that are spaced apart in a depth direction D, first and second ends 180C, 180D that are spaced apart in a longitudinal (or height) direction L, and first and second sides 180E, 180F that are spaced apart in a transverse (or width) direction T. The HUT 110 is connected to the top wall 180A.

The PLSS has a first set of slots 181 and a second set of slots 182. More specifically each side 180E, 180F of the PLSS 180 has first and second slots 181A, 181B, which define the first set of slots 181. Each side 180E, 180F of the PLSS 180 has third and fourth slots 182A, 182B, which define the second set of slots 182. The first set of slots 181 are longitudinally aligned with each other and have a same shape as each other. The second set of slots 182 are also longitudinally aligned with each other and have a same shape as each other. The first set of slots 181 may be closer to the first end 180C than the second set of slots 182, though this not intended on limiting the longitudinal arrangement of the attachment assemblies.

As shown in FIG. 1C, the first set of slots 181 (only the first slot 181A is shown for simplicity) each have an outer portion 181C that extends in the depth direction from the bottom wall 180B toward the top wall 180A to an inner slot end 181D that is intermediate the top and the bottom. The outer portion 181C has a converging segment 181C1 and a linear segment 181C2, which extends between the converging segment 181C1 and the inner slot end 181D. The inner slot end 181D defines an oblong-shaped groove 181E having a long axis 181F that extends in the longitudinal direction. The purpose of the shape of the first set of slots 181 is discussed below.

As shown in FIG. 1D, the second set of slots 182 (only the third slot 182A is shown for simplicity) each have an outer portion 182C that extends in the depth direction from the bottom wall 180B toward the top wall 180A to an inner slot end 182D that is intermediate the top and the bottom. The outer portion 182C has a converging segment 182C1 and a linear segment 182C2 that extends from the converging segment 183C1 to the inner slot end 182D. The inner slot end 182D defines a pin-shaped groove (or depression) 182E. The purpose of the shape of the second set of slots 182 is discussed below.

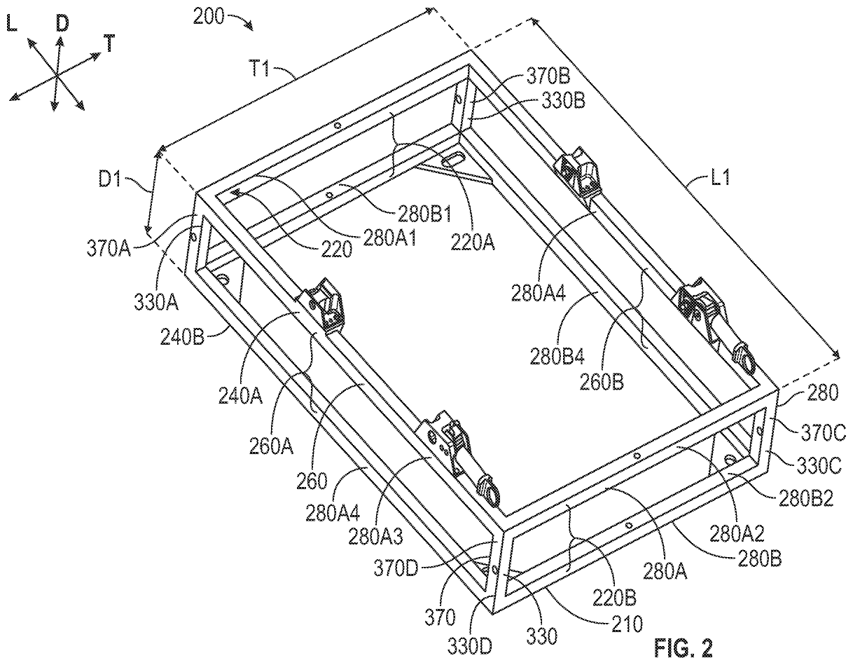

Turning to FIG. 2, a system 200 is disclosed for storing the PLSS 180 and the HUT 110 of the atmospheric suit 100. The system 200 includes a frame 210. The frame 210 defines opposite ends 220, including first and second ends 220A, 220B, that are spaced apart in the longitudinal direction L. A top and bottom 240A, 240B (generally 240) are spaced apart in the depth direction D. The frame 210 defines opposite sides 260, including first and second sides 260A, 260B, that are spaced apart in the transverse direction T. As discussed in greater detail below, the PLSS 180 is storable and removable via the top 240A of the frame 210.

The frame 210 forms a rectangular parallelepiped. A longitudinal size L1 of the frame 210 is greater than a transverse size T1 of the frame 210. The transverse size T1 of the frame 210 is greater than a depth D1 of the frame 210.

The frame 210 is formed by perimeter frame members 280, including top frame members 280A and bottom frame members 280B. The top frame members 280A include first and second top-end frame members 280A1, 280A2 that are opposite each other and first and second top-side frame members 280A3, 280A4 that are opposite each other. The bottom frame members 280B include first and second bottom-end frame members 280B1, 280B2 that are opposite each other and first and second bottom-side frame members 280B3, 280B4 that are opposite each other. The frame members 280 in the top and bottom 240 define four perimeter corners 330A-330D, generally 330. Corner frame members 370A-370D, generally 370, extend in the depth direction D at the corners 330, between the top and bottom 240 of the frame 210. With this configuration, the frame members 280 define the frame ends 220, the frame sides 260 and the top and bottom 240 of the frame 210.

Turning to FIG. 3, a first set of attachment assemblies 480, including first and second attachment assemblies 480A, 480B are releasably connected to the top 240A of the frame 210 at ones of the first and second sides 260A, 260B. The first set of attachment assemblies 480 are configured the same as each other.

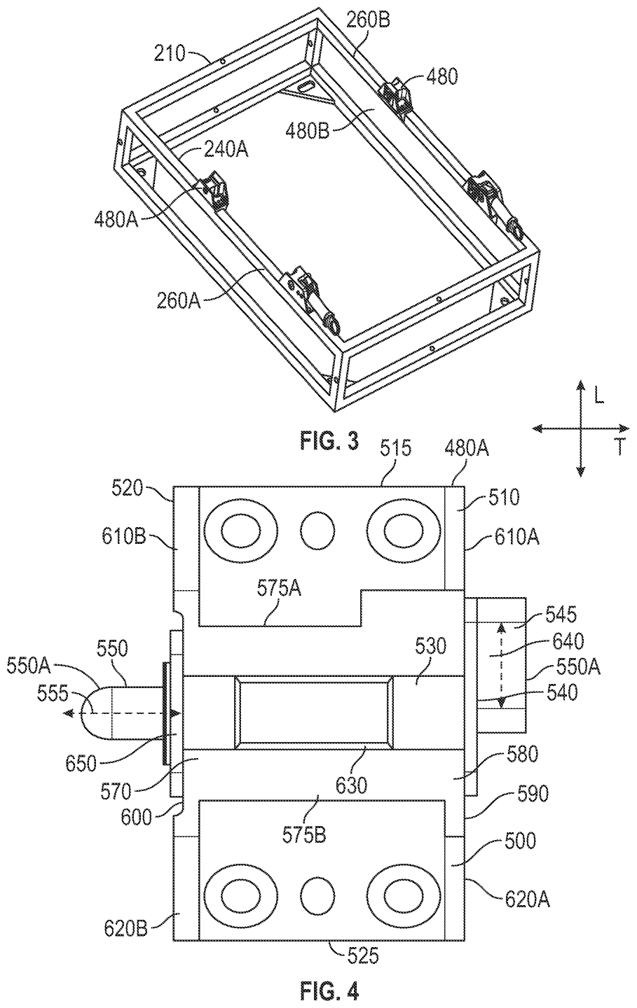

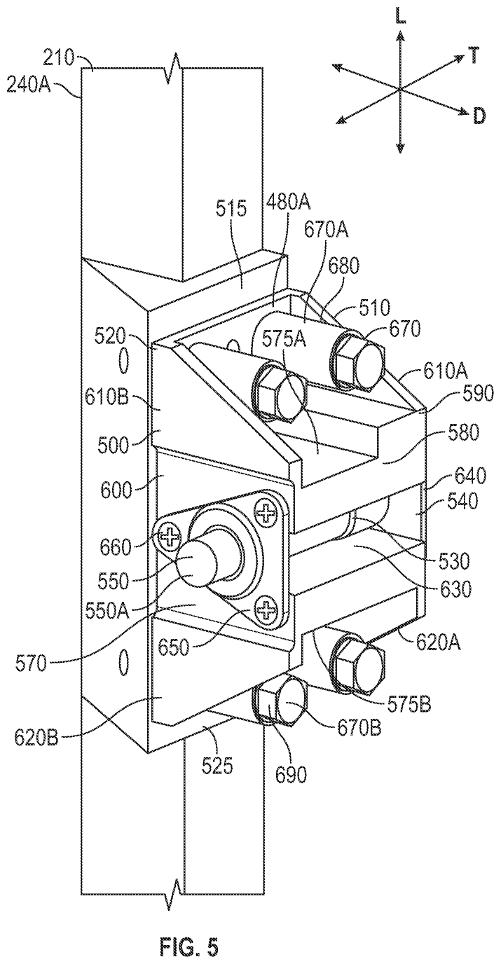

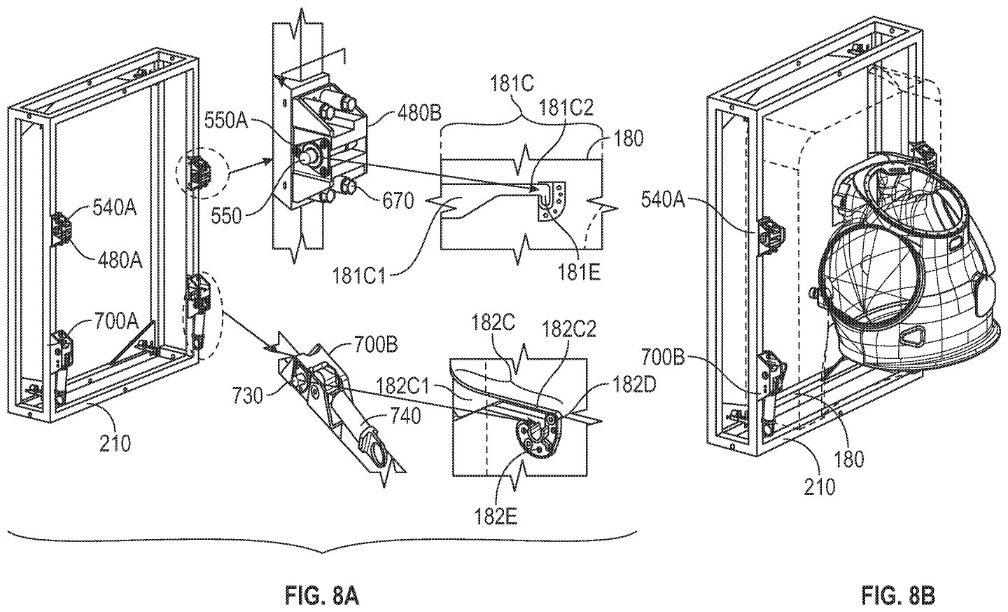

As shown in FIGS. 4 and 5, each of the first and second attachment assemblies 480 (one is shown for simplicity) includes a bracket (or first bracket) 500 extending in the transverse direction T between first and second sides 510, 520 and in the longitudinal direction L between first and second ends 515, 525 to define a perimeter of the bracket 500. A shaft 530, secured to the bracket 500, extends in the transverse direction T from a first end 540 that extends past the first side 510 of the bracket 500 to a second end 550 that extends past the second side 520 of the bracket 500. The first end 540 of the shaft 530 defines a fixed oblong-shaped boss (or protrusion) 540A with a long or major axis 545 that extends along the longitudinal direction L (a profile of the oblong-shaped boss is also shown in FIG. 8). The second end 550 of the shaft 530 defines a fixed pin-shaped boss 550A with a center axis 555 that extends along the transverse direction T.

A block portion 570 is longitudinally centered on the bracket 50. The block portion 570 longitudinally extends from a first end 575A to a second end 575B. The block portion extends in the depth direction D from to a top face 580. The block portion 570 extends in the transverse direction T to define a first side 590 and a second side 600 of the block portion 570. Stiffening flanges 610A, 610B, 620A, 620B, each with a triangular profile, may extend from both longitudinal ends 575A, 575B of both sides 590, 600 of the block portion 570, to the opposite longitudinal ends of the bracket 500. That is, first flanges 610A, 620A may extend from opposite longitudinal ends of the first side 590 of the block portion 570 and second flanges 610B, 620B may extend from opposite longitudinal ends of the second side 600 of the block portion 570. With this configuration, the first set of attachment assemblies 480 have a trapezoidal shape in a side-view.

The block portion 570 defines a channel 630 that extends in the transverse direction T, between the first and second sides 590, 600 of the block portion 570 and is longitudinally centered on the block portion 570. The channel 630 receives the shaft 530.

The shaft 530 has a first flange 640 and a second flange 650 that are transversely spaced apart from each other. The first flange 640 is secured transversely against the first side 590 of the block portion 570 and the second flange 650 is secured transversely against the second side 600 of the block portion 570. The first end 540 of the shaft 530 extends from the first flange 640 and the second end of the shaft 550 extends from the second flange 650. Fasteners (or first fasteners) 660, which may be screws as a nonlimiting example, secure the first flange 640 and the second flange 650 to the block portion 570. The fasteners 660 engage the flanges in the transverse direction T.

As shown in FIG. 5, the first set of attachment assemblies 480 are releasably secured to the top 240A of the frame via fasteners (or second fasteners) 670, which may be different than fasteners 660, that engage the frame in the depth direction D. As shown FIG. 5, the fasteners 670 are bolts. In some embodiments, the fasteners 670 are screws. Standoffs 680 are included so that when the fasteners 670 are secured to the frame 210, heads 690 of the fasteners 670 are spaced in the depth direction D from the top 240A of the frame 210.

A first set 670A of the fasteners 670 engage the bracket 500 between the first end 515 of the bracket 500 and the block portion 570. A second set 670B of the fasteners 670 engage the bracket 500 between the second end 525 of the bracket 500 and the block portion 570. Each set of the fasteners 670 includes at least two fasteners.

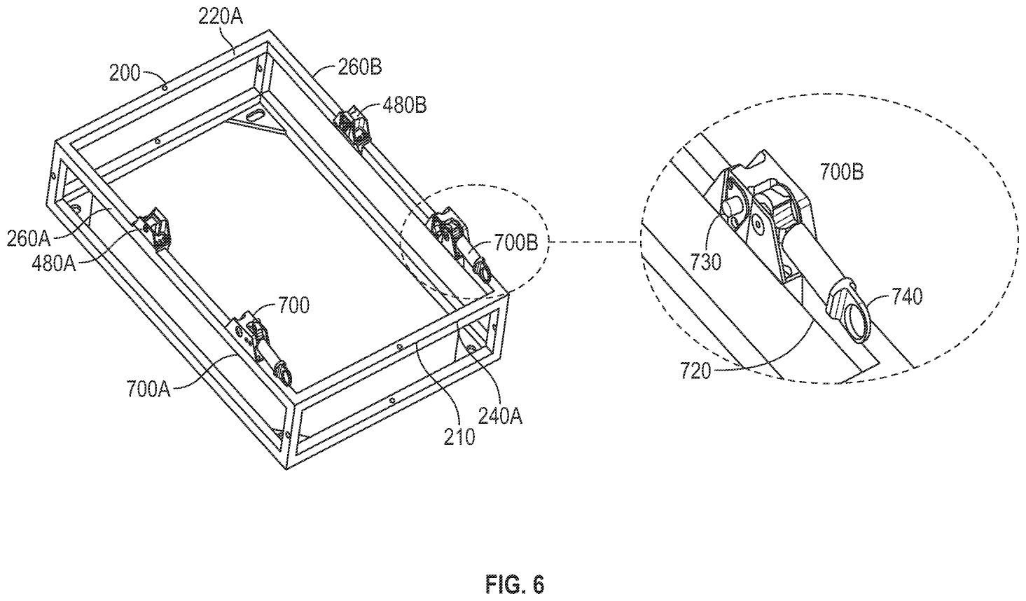

Turning to FIG. 6, the system 200 includes a second set of attachment assemblies 700, including third and fourth attachment assemblies 700A, 700B, connected to the top 240A of the frame 210 at ones of the first and second frame sides 260A, 260B. The second set of attachment assemblies 700 are configured the same as each other. The first set of attachment assemblies 480 may be closer to the first end 220A of the frame 210 than the second set of attachment assemblies 700, though this is not intended on limiting the positioning of the attachment assemblies.

Each of the third and fourth attachment assemblies 700A, 700B (the details of the fourth attachment assembly 700B are shown) includes a bracket (or second bracket) 720. A spring loaded, retractable pin-shaped boss 730 is operationally connected to the bracket 720. The retractable pin-shaped boss 730 extends in the transverse direction T such that the retractable pin-shaped boss 730 in each of the third and fourth attachment assemblies 700A, 700B face each other on the frame 210. A lever 740 is secured to the bracket 720. The lever 740 is pivotable to retract the retractable pin-shaped boss 730.

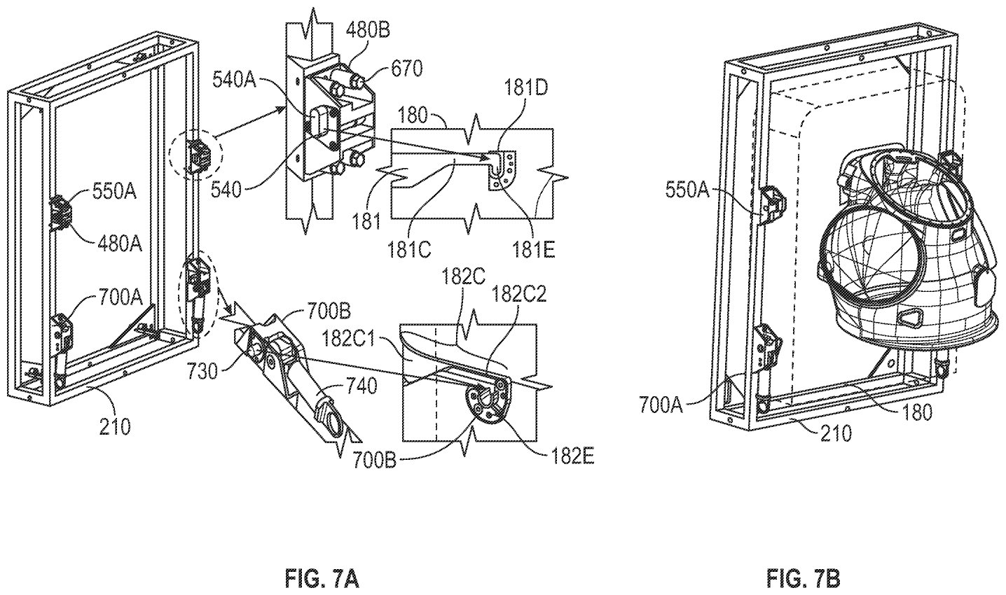

Turning to FIGS. 7A and 7B, the first set of attachment assemblies 480, as indicated, is removable, and is configured for being selectively arranged in a first orientation in which the oblong-shaped bosses 540A face inwardly, toward each other, to fix the PLSS 180 to the frame 210, while the fixed pin-shaped bosses 550A face outwardly. For this configuration, prior to securing the first set of attachment assemblies 480 to the frame 210, the oblong-shaped bosses 540A are placed directly in respective ones of the oblong-shaped grooves 181E of the first and second slots 181. The first set of attachment assemblies 480, together with the PLSS 180 and HUT 110, are then secured to the frame 210 via the top facing fasteners 670. As can be appreciated, this configuration functions in a keyed relationship between the first set of attachment assemblies 480 and first and second slots 181 of the PLSS 180. Thus, securing the first set of attachment assemblies 480 to the frame 210 locks the PLSS 180 to the frame 210.

In this configuration, in the second set of attachment assemblies 700, the converging segment 182C1 of the outer portion 182C of the second set of slots 182 guides the retractable pin-shaped boss 730 toward the linear segment 182C2 of the second set of slots 182. Within the linear segment 182C2 of the second set of slots 182, the retractable pin-shaped boss 730 is guided to the pin-shaped groove 182E at the inner slot ends 182D. In this configuration, the retractable pin-shaped boss 730, whether or not retracted, would not release the PLSS 180 from the frame 210. This is because the oblong-shaped bosses 540A in the first set of attachment assemblies 480 cannot move in the depth direction D along the outer portion 181C of the first set of slots 181. This configuration is utilized, e.g., when transporting the PLSS 180 and HUT 110 between an initial location and an end destination, such as the earth and an orbital destination of a spacecraft, or to a stationary structure such as a station on the moon.

To remove the PLSS 180 and HUT 110 upon reaching the end destination, the first set of attachment assemblies 480 are released from the frame 210 via the top facing fasteners 670. Upon release of the first set of attachment assemblies 480, the oblong-shaped bosses 540A are removed from the oblong-shaped grooves 181E.

It is to be appreciated that the fasteners 660 that engage the flanges 640, 650 may be inaccessible from the front of the frame 210 because of being blocked by the PLSS 180. Thus, having fasteners 670 engage the first set of attachment assemblies 480 in the depth direction enables removal of the PLSS 180 from the first set of attachment assemblies 480 when the oblong-shaped bosses engage the PLSS 180.

Turning to FIGS. 8A and 8B, in a second orientation, the top facing fasteners 670 are loosened, if the first set of attachment assemblies 480 are not already removed from the frame 210, and the first and second attachment assemblies 480 are each rotated 180 degrees from the first orientation. The first set of attachment assemblies 480 are then reattached to the frame 210 via the top facing fasteners 670. In the second orientation, the pin-shaped boss 550A of the first and second attachment assemblies 480 face each other. The first set of attachment assemblies 480, in this configuration, releasably position the PLSS 180 against the frame 210, while the second set of attachment assemblies 700 releasably secure the PLSS 180 to the frame 210.

In the configuration shown in FIGS. 8A and 8B, when positioning the PLSS 180 against the frame 210, the converging segment 181C1 of the outer portion 181C of the first set of slots 181 guides the fixed pin-shaped boss 550A of the first set of attachment assemblies 480 toward the linear segment 181C2. Within the linear segment 181C2 of the first set of slots 181, the fixed pin-shaped boss 550A of the first set of attachment assemblies 480 is guided to the slot ends 181D.

In this configuration, the converging segment 182C1 of the outer portion 182C of the second set of slots 182 guides the retractable pin-shaped boss 730 of the second set of attachment assemblies 700 toward the linear segment 182C2. Within the linear segment 182C2 of the second set of slots 182, the retractable pin-shaped boss 730 is guided to the pin-shaped groove 182E at the inner slot ends 182D. In this configuration, the retractable pin-shaped boss 730, if later retracted, would release the PLSS 180 from the frame 210, enabling removal of the PLSS 180. This is because the pin-shaped boss 550A in the first set of attachment assemblies 480 can move in the depth direction D along the outer portion 181C of the first set of slots 181. This configuration is utilized, e.g., when the PLSS 180 and HUT 110 are at a location where the spacesuit is expected to be donned and doffed.

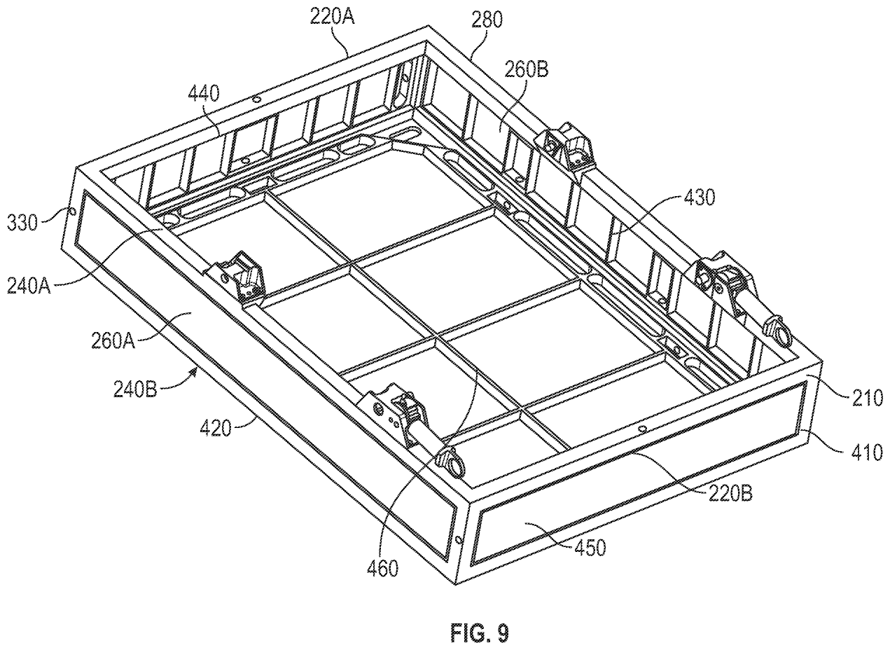

Turning to FIG. 9, the system 200 includes removable base stiffening panels 410 that are releasably connected to the frame 210 to provide extra stiffness to the frame 210, e.g. during transport. First and second side panels 420, 430 are connected to the frame members 280 along ones of the first and second sides 260A, 260B of the frame 210 and extend between the top and bottom 240A, 240B of the frame 210 and between adjacent ones of the corners 330. First and second end panels 440, 450 are connected to the frame members 280 along ones of the first and second ends 220A, 220B of the frame 210 and extend between the top and bottom 240 of the frame 210 and adjacent ones of the corners 330. A bottom panel 460 is connected to each of the frame members 280 along the bottom 240B of the frame 210.

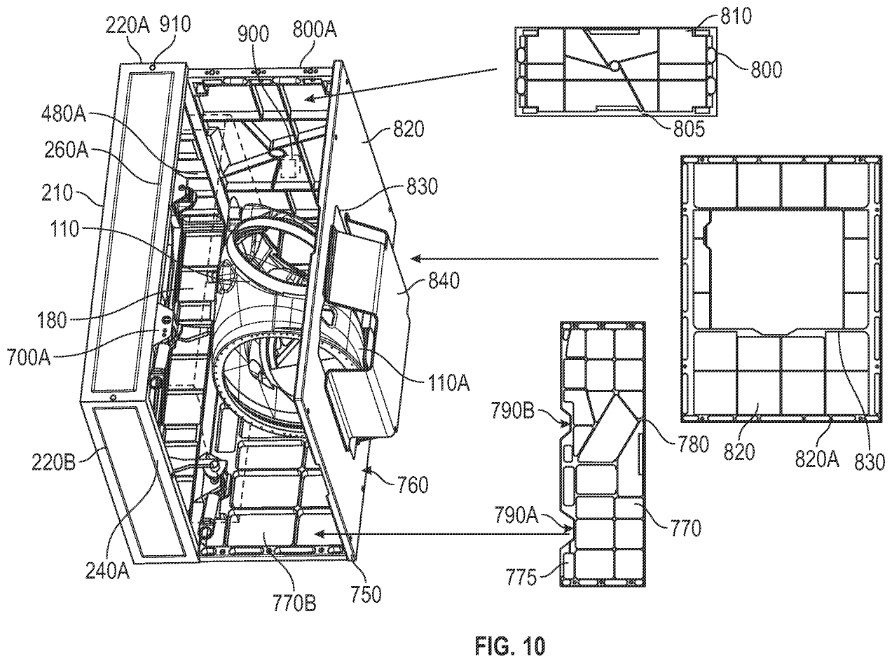

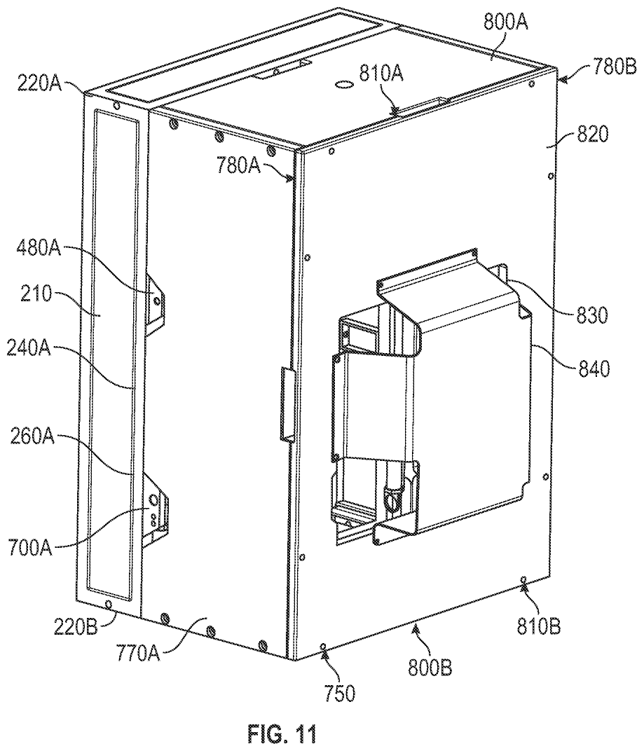

Turning to FIGS. 10 and 11, the system 200 includes HUT cover 750 formed of cover panels generally referenced as 760. The HUT cover 750 may be utilized, e.g., during transport, forming a complete launch enclosure, and can be secured to a launch vehicle.

The HUT cover 750 includes side panels 770, e.g., first and second side panels 770A, 770B, that are configured the same as each other and are connected to the frame members 280 along ones of the frame sides 260A, 260B. Each of the side panels 770 extends in the depth direction D away from the top 240A of the frame 210, from an inner end, 775, to an outer end 780. The side panels 770 of the HUT cover 750 each define first and second contours 790A, 790B that fit about each of the attachment assemblies 480, 700.

The HUT cover 750 includes end panels 800, e.g., first and second end panels 800A, 800B, that are connected to the frame members 280 along ones of the frame ends 220A, 220B. Each of the end panels 800 extends in the depth direction D away from the top 240A of the frame 210, from an inner end 805) to an outer end 810.

A top panel 820 is connected to the outer ends 780 of the side panels 770 and the outer ends 810 of the end panels 800. The top panel 820 defines a rectangular outer perimeter 820A and a center aperture 830 though which a portion 110A of a top of the HUT 110 extends when the PLSS 180 and HUT 110 are secured to the frame 210 (FIG. 10). A supplemental cover portion 840 is connected to the top panel 820 to cover and protect the portion 110A of the top of the HUT 110, e.g., during transport.

In the disclosed system there is clearance between the frame 210 and the PLSS 180 as shown in FIG. 10. Foam 900 may be inserted into this space for packing purposes. The panels 410 and 760 may be fastened to each other and the frame 210 via fasteners (or third fasteners) 910, such as screws. The fixed and retractable pin-shaped bosses 550A, 730 and the shape of the slots 181, 182 may simplify donning and doffing the PLSS 180 and HUT 110. In one embodiment, rather than the fixed oblong-shaped boss 540A and pin-shaped boss 550A being connected to each other via the shaft 530, they may each be connected to the first and second attachment assemblies 480 via the first and second flanges 640, 650.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system for storing a primary life support subsystem (PLSS) that is connected to a hard upper torso (HUT) of an atmospheric suit, the system comprising:
a frame having: a top and a bottom that are spaced apart from each other in a depth direction;
first and second ends that are spaced apart from each other in a longitudinal direction; and
first and second sides that are spaced apart in a transverse direction, and the PLSS is storable and removable via the top of the frame;
a first set of attachment assemblies, including first and second attachment assemblies, releasably connected to the top of the frame, along the first and second sides of the frame, wherein the first and second attachment assemblies each include:
a first bracket extending transversely between first and second sides and longitudinally between first and second ends;
a fixed oblong-shaped boss connected to the first side of the bracket and extending in the longitudinal direction; and
a fixed pin-shaped boss connected to the second side of the bracket and extending in the transverse direction,
wherein the first set of attachment assemblies is selectively arrangeable in a first orientation in which the oblong-shaped boss of the first and second attachment assemblies face each other to fix the PLSS to the frame, and a second orientation in which the oblong-shaped boss of the first and second attachment assemblies face away from each other to releasably position the PLSS against the frame.

2. The system of claim 1, wherein:
the frame is shaped as a rectangular parallelepiped; and
a longitudinal size of the frame is greater than a transverse size of the frame, and the transverse size of the frame is greater than a depth of the frame.

3. The system of claim 1, wherein:
the first and second attachment assemblies further comprise a first flange secured to the first side of the bracket and a second flange secured to the second side of the bracket; and
the oblong-shaped boss is integral with the first flange and the pin-shaped boss is integral with the second flange.

4. The system of claim 3, wherein:
the first and second attachment assemblies further comprise a block portion, longitudinally centered on the bracket of the first and second attachment assemblies;
the block portion defines a channel that extends in the transverse direction, between the first and second sides of the bracket; and
a shaft is disposed in the channel, extending between the first and second flanges, so that the oblong-shaped boss, the shaft, and the pin-shaped boss form an integral structure.

5. The system of claim 4, wherein
fasteners secure the first and second flanges to the bracket, wherein the fasteners engage the first and second flanges in the transverse direction.

6. The system of claim 4, wherein
the first set of attachment assemblies is releasably secured to the frame via fasteners that engage the frame in the depth direction.

7. The system of claim 6, wherein
the fasteners are bolts or screws.

8. The system of claim 7, including
fastener standoffs, wherein when the fasteners are secured to the frame, heads of the fasteners are spaced in the depth direction from the frame via the fastener standoffs.

9. The system of claim 1, including:
a second set of attachment assemblies, including third and fourth attachment assemblies, each including:
a second bracket;
a spring-loaded retractable pin-shaped boss connected to the second bracket and extending inwardly in the transverse direction, whereby the retractable pin-shaped boss in the third and fourth attachment assemblies face each other; and
a lever secured to the bracket, wherein the lever is pivotable to retract the retractable pin-shaped boss.

10. The system of claim 9, wherein:
when the oblong-shaped boss of the first and second attachment assemblies face each other and engage the PLSS, the PLSS is fixed to the frame; and
when the fixed pin-shaped boss of the first and second attachment assemblies face each other and engage the PLSS, and the retractable pin-shaped boss is retracted, the PLSS is removable from the frame.

11. The system of claim 10, wherein
the first set of attachment assemblies are closer to the first end of the frame than the second set of attachment assemblies.

12. The system of claim 11, wherein:
the frame is formed of frame members such the top and bottom of the frame each include:
first and second end frame members that are spaced apart in the longitudinal direction; and
first and second side frame members that are spaced apart in the transverse direction.

13. The system of claim 12, further comprising:
base stiffening panels, including:
first and second base side panels connected to the frame members along ones of the first and second sides of the frame;
first and second base end panels connected to the frame members along ones of the first and second ends of the frame; and
a bottom panel connected to the frame members along the bottom of the frame.

14. The system of claim 13, further including:
HUT cover panels, including:
first and second cover side panels connected to the frame members along ones of the first and second sides of the frame, each extending in the depth direction away from the top of the frame to an outer end, wherein the first and second cover side panels of the HUT cover define contours that fit about each of the first and second sets of attachment assemblies;
first and second cover end panels connected to the frame members along ones of the first and second ends of the frame, each extending in the depth direction away from the top of the frame to outer ends; and
a top panel connected to the outer ends of the first and second cover side panels and the first and second cover end panels of the cover panels.

15. The system of claim 14, wherein:
the top panel defines a center aperture though which a portion of a top of the HUT extends when the PLSS and HUT are secured to the frame; and
the top panel includes a supplemental cover portion that covers the portion of the top of the HUT.

16. The system of claim 15, comprising:
a PLSS having a top, a bottom and first and second sides, and a HUT connected to the top of the PLSS, wherein the PLSS includes:
a first set of slots, including first and second slots, each having an outer portion that extends in the depth direction from the bottom of the PLSS to an inner slot end that is intermediate the top and the bottom, and a longitudinally extending oblong-shaped groove is defined at the inner slot end of the first set of slots; and
a second set of slots, including third and fourth slots, each extending in the depth direction from the bottom of the PLSS to an inner slot end that is intermediate the top and the bottom, and a pin-shaped groove is defined at the inner slot end of the second set of slots.

17. The system of claim 16, wherein
in the first orientation of the first set of attachment assemblies:
the oblong-shaped boss of the first and second attachment assemblies extend into the oblong-shaped groove of the first and second slots;
the retractable pin-shaped boss of the third and fourth attachment assemblies extend into the pin-shaped groove of the third and fourth slots; and
the PLSS is fixed to the frame.

18. The system of claim 17, wherein
in the second orientation of the first set of attachment assemblies:
the fixed pin-shaped boss of the first and second attachment assemblies extend into the oblong-shaped groove of the first and second slots;
the retractable pin-shaped boss of the third and fourth attachment assemblies extend into the pin-shaped groove of the third and fourth slots; and
engaging the lever of the third and fourth attachment assemblies retracts the retractable pin-shaped boss of the third and fourth attachment assemblies, whereby the PLSS is removable from the frame.
